(19) United States
(12) Patent Application Publication
(10) Pub. No.: US 2024/0370988 A1
(43) Pub. Date: Nov. 7, 2024

(54) METHOD AND APPARATUS FOR INSPECTING CONTAINER CLOSURES ARRANGED ON CONTAINERS

(71) Applicant: KRONES AG, Neutraubling (DE)

(72) Inventors: Anton NIEDERMEIER, Offenstetten (DE); Stefan SCHOBER, Tegernheim (DE)

(21) Appl. No.: 18/685,134

(22) PCT Filed: May 31, 2022
(86) PCT No.: PCT/EP2022/064824

§ 371 Date: Feb. 20, 2024

(30) Foreign Application Priority Data
Aug. 19, 2021 (DE) 10 2021 121 489.0

(51) Int. Cl. G06T 7/00; B65B 7/28; B65B 57/00; B65D 41/34; B65D 55/16; G06T 7/73; G06T 7/90

(52) U.S. Cl. CPC G06T 7/0004; B65B 7/28; B65B 57/00; B65D 41/3447; B65D 55/16; G06T 7/73; G06T 7/90; B65D 2401/30; G06T 2207/30204

(57) ABSTRACT

Disclosed is a method for inspecting containers provided with container closures, wherein the container closure has a closure cap screwed onto a mouth of the container, a securing device arranged on the container below the mouth in a longitudinal direction of the container, a connecting strand that connects the securing device to the closure cap, a first fastening section where the connecting strand is fastened to the closure cap, and a second fastening section with which the connecting strand is arranged on the securing device, wherein the containers are transported by a transport device and inspected by an inspection unit, wherein a first marking located on the container is recorded in order to determine the rotational position of the container closure from a position of the connecting strand and/or a position of at least one fastening section.

The present invention relates to a method and an apparatus for inspecting containers with container closures arranged thereon. In particular, the invention relates to a method and to an apparatus that are intended to check whether container closures, in particular screw caps, are correctly screwed onto containers.

In the field of the beverage producing industry, it is known that machines initially fill containers and then close them with closures. An essential criterion is the question of whether the container closures are screwed properly or sealingly onto the mouths or the threads of the containers.

For this purpose, a series of inspection systems is known from the prior art. It is therefore known that markings are applied both to the containers themselves and to the closures, which markings can be detected by an inspection device, and information about a rotational position of the container and the closure is therefore obtained.

By comparing these markings or their rotational positions, it is possible to infer the state of the closure. For example, disposable PET containers and their screw closures have unique markings. The marking(s) is (are) arranged in a fixed relation to a thread orientation. If the container closure is applied correctly, the two markings must be at a certain angle to one another (in particular an angle relative to the container axis or the longitudinal direction of the container) or in a different type of relationship. Manufacturing and application tolerances are defined by the permissible tolerated spacing of the two markings. As long as the closure and container markings lie within these tolerances, it is ensured that the sealing concept (closure and mouth piece) works correctly.

Usually, markings which have a fixed relationship to the phase position of the thread in the closure piece and are applied as visually inconspicuously as possible are arranged on the closure. For example, it is known that part of a knurled region is somewhat shortened.

It is usual to use support ring markings or markings in the neck region below a support ring on the containers, which markings have a fixed relationship to the phase position of the thread on the mouthpiece. The containers preferably have a support ring. The containers are preferably produced from a transparent material, for example PET.

The closures commonly used to date are usually without a logo or embossing on the cover. If such features were present, it was not certain that they were in a phase relationship with the thread in the mouthpiece.

A new type of closures is now known, so-called tethered caps. What these have in common is that they have some form of lasso function. This function has the effect that the closure remains connected via the lasso to the retaining ring arranged on the container, even after it has been opened.

To ensure that the closure can still remain compact, the lasso or the section referred to below as the connecting strand should not be longer than necessary. From this it follows that the lasso or connecting bar or connecting strand should have a certain minimum length, but should also be no longer than necessary. In other words, the bar or strand or lasso will be just long enough so that upon being screwed on, the bar or strand can work upon reaching the end of the thread. Technically, this lasso function has a fixed relationship to the closure thread.

A disadvantage in the prior art is that the closure rotation angle or its feature is difficult to detect in the case of conventional closures. There are many approaches to this in the prior art. None of them are easy to use in practice. There is no 100% true and/or 100% reliable inline inspection technique. Typically, a sample is inspected by hand.

The present invention is therefore based on the object of realizing a monitoring of such closures which remain arranged on containers. This is achieved according to the invention by the subject matter of the independent claims. Advantageous embodiments and developments are the subject matter of the dependent claims.

In a method according to the invention for inspecting containers provided with container closures, wherein the container closure has a closure cap screwed onto a mouth of the container, a securing means arranged on the container below the mouth in a longitudinal direction of the container, at least one connecting strand or connecting bar that connects the securing means to the closure cap, a first fastening section on and/or with which the connecting strand is fastened to the closure cap, and a second fastening section on and/or with which the connecting strand is arranged on the securing means, wherein the containers are transported by a transport device and inspected by an inspection device, wherein a rotation and/or a rotational position of the closure cap relative to the container is determined, and wherein a first marking (or feature) located on the container is detected and or recorded in order to determine the rotational position.

According to the invention, a rotational position of the container closure is determined (with respect to the container and/or with respect to a longitudinal direction of the container) from a position of the connecting strand and/or a position of at least one fastening section.

Preferably, the securing means is a retaining ring which preferably always remains on the container independent of an opening state of the container. In this case, it is possible for this retaining ring to be in connection with the closure cap when the container is in a still unopened state, and to be separated from the closure cap by the first opening process and then preferably be spaced apart from the closure cap in the longitudinal direction of the container. Preferably, this retaining ring is rotatable relative to the container (in particular substantially free).

The fastening section is preferably a joint section on which the connecting strand is arranged on the closure cap or the securing means.

It is therefore proposed that the information from which the rotational position of the container closure relative to the container is derived is not determined by markings affixed to the container closure for this purpose; instead, the connecting strand or the fastening of the securing means is used for this purpose.

According to the invention, it is therefore proposed that, in the new type of tethered caps described, their lasso function or the connecting strand is used as a feature on the closure.

This lasso function can be implemented differently from closure manufacturer to closure manufacturer. Nevertheless, the basic principle of the fixed phase relationship of the lasso or connecting strand to the thread in the closure remains the same. Depending on the type of container closure, however, this phase relationship may vary.

In a preferred method, a 360° detection of the container closure is used. This detection can preferably detect both the closure and the connecting strand as well as parts thereof. This detection may also detect the type of closure or connection strand (technical implementation, the manufacturers, closure locations). In a preferred method, an offset between the container closure (or its rotational position) and the container (or its rotational position) or generally a correction value is determined on the basis of this information.

In a preferred method, a visual feature is used to inspect the connection between the container closure and the container. The inspection device therefore preferably performs a visual determination. In a preferred method, at least one image of the container closure and/or the connecting strand and/or the fastening section(s) is recorded.

Preferably, this is a spatially resolved image. In particular, at least one fastening section and in particular the first fastening section is inspected.

However, it would also be possible for several properties of the connection between the container closure and the securing means to be inspected, in particular in order to refine and or check a corresponding image evaluation. The type of the container closure can also be deduced from these features.

In a further preferred embodiment, the container closure has an internal thread. Preferably, the container itself has an outer thread.

Preferably, the mentioned features (i.e., the connecting strand and/or the fastening sections) are in a fixed phase relationship with the thread of the closure. This phase relationship can differ depending on the container closure, however, it is advantageously predetermined for any type of container closures.

In a further preferred method, a type of container closures is also determined by means of the inspection device, or at least one value is determined which is characteristic of this type. Particularly preferably, the container closure and/or its type is (in particular clearly) identified.

For each container closure, a reference value, for example a reference value for an offset (in particular between the thread and the connecting strand and/or the fastening sections), can be indicated for each container closure.

Preferably, a type of the container closure is therefore taken into account for determining the rotational position of the container closure relative to the container. An offset between the feature, i.e., the position of the connecting strand and/or the fastening section(s) and the thread of the container closure can preferably be taken into account.

In a particularly preferred method, a type of container closure is predetermined and/or is determined and/or taken into account, and a value is determined therefrom which is characteristic of a relative position between a thread of this closure and the thread.

For example, it can be known for container closures of type A that a start of a thread is rotated by +30° relative to the position of the connecting strand, while the corresponding rotational angle is 10° for container closures of type B. These values can be used in the evaluation of a determined rotational position.

In a further preferred method, the container is transported during the inspection. In a further preferred method, the container and/or the container closure is illuminated during the inspection and in particular for recording an image with a lighting device such as a flash lamp.

In a further preferred method, the container is a plastic container and in particular a plastic bottle. In a further preferred method, the container or containers are closed by means of at least one closing member, preferably a plurality of closing members, prior to inspection.

In this case, it is possible for the operating mode of individual closing members to be corrected and/or changed within the scope of the inspection. In a further preferred method, defective closed containers are discharged from the transport path of the containers.

In a further preferred method, at least one image of an upper side of the container is recorded. This can be, for example, a complete image of the container closure and/or a 360° image.

In a further advantageous method, the marking located on the container is recorded with the same inspection device, such as the position of the connecting strand and/or the position of the fastening section or sections. Alternatively, however, it would also be possible for the container closure to be recorded with a first inspection device, and the container itself or the marking located on the container to be recorded with a further inspection device.

Preferably, from at least one recorded image of the container closure, a position of the container closure is inferred with respect to the container and, in particular, a rotational position of the container closure with respect to a longitudinal direction of the container.

In a further advantageous method, the inspection device determines at least one further property characteristic of the container closure and/or of its arrangement on the container.

In a particularly preferred method, this further property is selected from a group of properties which contains a color of the container closure, a type of the container closure, an orientation of the container closure on the container, damage to the container closure or the container, and the like. Accordingly, for example, a container closure arranged incorrectly or slanted on the container can also be recognized by the inspection.

In a further preferred method, the inspection device records at least one spatially resolved image of the container and/or the container closure. Preferably, an evaluation device determines from this image the position of the container closure on the container or the correct orientation. Artificial intelligence can be used for the evaluation. Preferably, a signal is output which is characteristic of a correct and/or incorrect rotational position of the container closure relative to the container.

In addition, it is also possible for an image to be evaluated by comparing it with reference images. Artificial intelligence may also possibly be used here. The container is preferably inspected in its longitudinal direction and/or perpendicular to its longitudinal direction. This makes it possible for the container to also be recorded (for example by the use of a mirror cabinet) from several sides and preferably from all sides.

In a further preferred method for inspecting the container and/or the container closure, an optical system and/or a mirror cabinet is preferably used. Particularly preferably, at least two cameras or image recording devices and preferably at least three cameras or image recording devices are used for inspecting the container closure and/or the container.

In a further preferred method, the detection of the container closure described here can also perform other testing tasks as mentioned above, such as the presence of a container closure, a missing closure, a poorly seated closure and the like.

In a further preferred method, the image of the container closure is recorded entocentrically, telecentrically or pericentrically. In addition, more than six image recording devices or cameras can also be used for inspection. In addition, a further image recording device or cameras can also be used which recognize a further marking of the closure, for example a logo and/or a brand of its manufacturer.

Particularly preferably, the marking is detected on the container, for example on its support ring or below this support ring in the same unit or in a further additional and/or specified unit. Preferably, the two positions of the features are determined in one or also in several evaluation devices or calculation units, or also in a outsourced evaluation device and/or calculation unit. If detection takes place at different transport location positions, this should preferably be taken into account when assigning the evaluation results.

Together with an assignment of the closing member, the error and also the rotation angle of each individual closing member can be visually parameterized, controlled and/or regulated. The corresponding closing member which has arranged this closure on the container can also preferably be identified when errors arise.

Accordingly, the present invention for the first time allows reliable detection of the orientation of a thread in a closure without an auxiliary mark that is required in the prior art. Together with the feature on the container, a stable and robust detection of the closure rotation angle position can be determined. In addition, this enables real leakage detection of the container.

The invention can be combined together with other useful checks listed above in one unit. The present invention therefore also works even with difficult colors or container closures.

The present invention is also directed to an apparatus for inspecting containers provided with container closures, wherein the container closure has a closure cap to be screwed onto a mouth of the container (or a closure cap screwed onto the container), a securing means to be attached (or arranged) on the container below the mouth in a longitudinal direction of the container, a connecting strand connecting the securing means to the closure cap, a first fastening section on and/or with which the connecting strand is fastened to the closure cap, and a second fastening section on and/or with which the connecting strand is arranged on the securing means.

Furthermore, the apparatus has a transport device which transports the containers along a predetermined transport path and an inspection device for inspecting the containers provided with the container closures (in particular during this transport, i.e., during the movement of the containers), which is suitable for determining a rotational position of the closure cap relative to the container, wherein a first marking located on the container is recorded and/or detected or can be detected in order to determine the rotational position.

According to the invention, the inspection device determines the rotational position of the container closure from a position of the connecting strand and/or a position of at least one fastening section.

It is therefore also proposed in terms of the apparatus that an element which connects the closure cap to the securing means is used to determine the rotational position. In this way, the evaluation or detection of the rotational position can be directed to a feature of the closure that is already technically necessary.

In a further advantageous embodiment, the apparatus has a closure device which closes the containers with the closures.

In a further advantageous embodiment, the apparatus has an image evaluation device which is suitable and intended for outputting, from at least one of the recorded images, at least one value which is characteristic of an angular position of the connecting strand and/or at least one fastening section.

Further advantages and embodiments result from the accompanying drawings.

In the drawings:

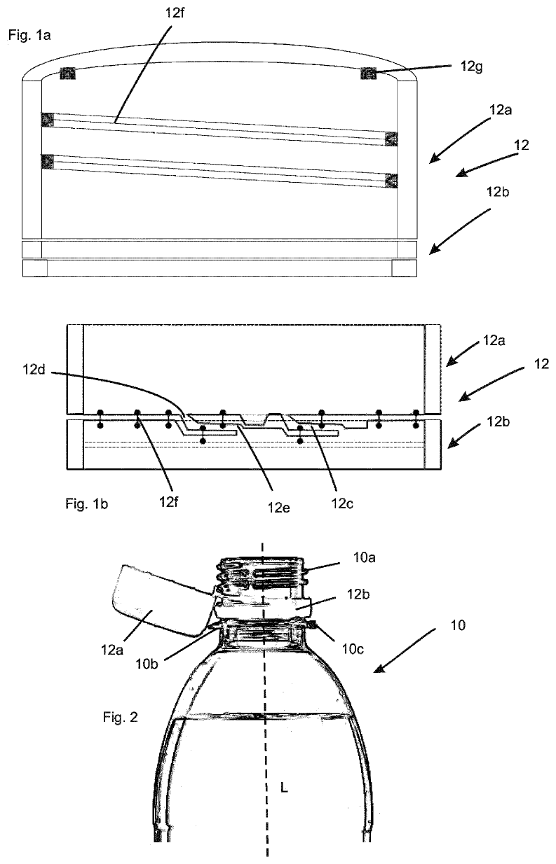

FIG. 1a, b show two schematic representations of a container closure;

FIG. 2 shows a representation of a container closure arranged on a container;

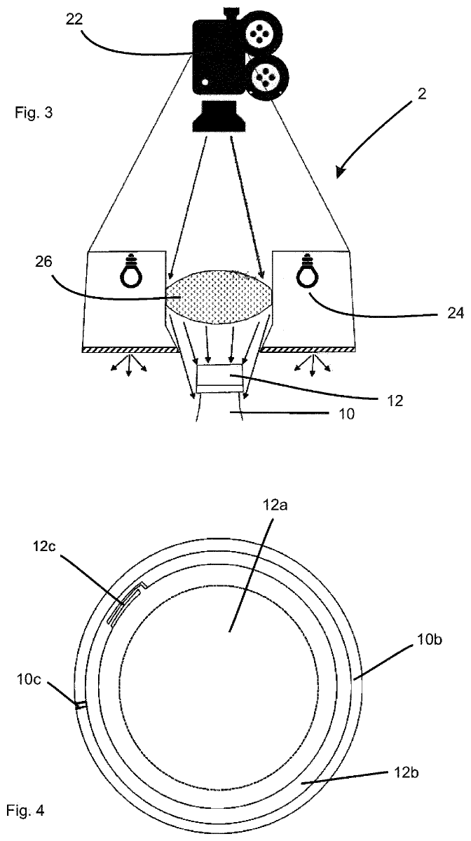

FIG. 3 shows a representation of an apparatus according to the invention in a first embodiment;

FIG. 4 shows a schematic representation of an image recorded with the apparatus from FIG. 3;

FIG. 5 shows a representation of an apparatus according to the invention in a second embodiment; and

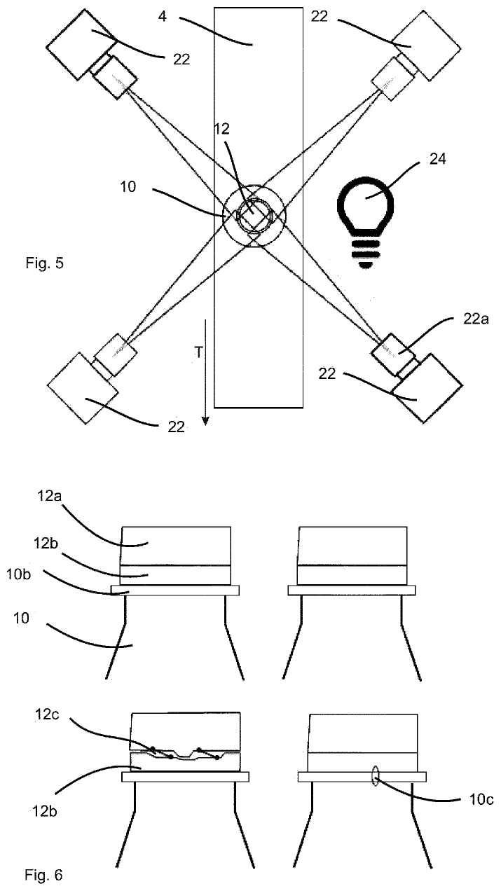

FIG. 6 shows a schematic representation of an image recorded with the apparatus from FIG. 5.

FIGS. 1a and 1b show a representation of a container closure 12. It has a closure cap 12a, in the interior of which an (inner) thread 12f is arranged in order to screw the closure cap onto a corresponding external thread of a container. The reference sign 12g indicates a sealing means which, in a closed state of the container, seals the closure 12 with respect to the container, more precisely with respect to the mouth edge of the container.

The reference sign 12b indicates a retaining ring which remains on the container even in a screwed-on state. The reference sign 12c indicates a connecting strand via which the retaining ring 12b remains connected to the closure cap 12a. The reference signs 12d and 12e indicate the respective fastening sections in which the connecting strand is fastened to the closure cap and to the retaining ring. These fastening sections can be designed as joint sections.

The reference sign 12f indicates a connection formed as a predetermined tearing point between the closure cap and the retaining ring, which is torn when the container is first opened. Preferably, a plurality of such predetermined tearing points is formed in the circumferential direction with respect to the container closure.

FIG. 2 shows a representation of a container closure 12 arranged on a container 10. This container 10 extends in the longitudinal direction L and has an external thread 10a. The reference sign 10b indicates a support ring, and the reference sign 10c indicates a marking arranged on this support ring 10b, which marking can be optically detected by an inspection device so that a rotational position of the container can be deduced.

FIG. 3 shows a schematic representation of an apparatus according to the invention in a first embodiment. An image recording device 22 is arranged above the container 10 in the longitudinal direction of the latter. This records an image of the container closure arranged on the container by means of a lens.

In suitable combination, the lens and the objective of the image recording device create a pericentric image and/or are to be regarded jointly as a pericentric objective. Pericentric objectives are special objectives in the measurement technology.

In contrast to conventional objectives, the beam path on the object side is not divergent, but convergent. This makes it possible to observe objects through an objective from several directions at the same time. Pericentric objectives are used, for example, to capture the entire circumferential surface and the front surface of a cylinder with a camera. The mouthpiece of the container and the closure is approximately a cylindrical body.

The reference sign 24 indicates a lighting device which is in the shape of a ring and accordingly fully illuminates the container closure.

In all of the embodiments described here, the image recording device preferably records an image of an illuminated container closure, so that an inspection is performed in each case using the reflected light method.

FIG. 4 shows an image recorded by the image recording device 22. The closure cap 12a can be seen as well as the support ring 10b of the container. The marking 10c on the support ring can also be seen in the recorded image.

In addition, the connecting strand 12c can be seen in the image here. In this way, an image evaluation device can determine the rotational position of the connecting strand 12c relative to the rotational position of the marking 10c. In this way, it is possible to infer the rotational position of the container closure relative to the container.

FIG. 5 shows a schematic representation of an apparatus 1 according to the invention in a second embodiment. In this embodiment, several image recording devices or cameras 22, in this case four, observe the container in a direction predominantly perpendicular to the longitudinal direction of the container. In addition, a lighting device 24 is also provided here.

The cameras can record at the same time and in sync with the (flash) illumination. The illumination preferably consists of a monolithic unit or several segments in the monolithic unit, for example, for the purpose of adapting the illumination to various closure types and or colors.

In addition, the illumination can be distributed locally in the detection. It is possible for each camera to record individually, or for a subgroup of cameras to record with an individual subset of the lighting. It is possible that the individual images of the camera are executed in rapid succession over time.

Preferably, the time interval between the individual images is less than 10 ms, preferably less than 5 ms, particularly preferably less than 2.5 ms. This has the advantage that the container is moved as little as possible. Furthermore, it is possible for one or more cameras to achieve quasi-simultaneous incident and transmitted light images by individually controlling the illumination setup.

It is thus easily understood that the one camera (in an illumination setup) can produce an incident light image and the opposite camera can produce a transmitted light image for the same setup. In this way, both incident light images and transmitted light images of the container and mouthpiece can be recorded within a short time.

It is advantageous if the setup is adapted to a specific closure location or also to a closure color.

The reference sign 4 indicates a transport device which transports the containers 10 along a transport path T (rectilinear in this case). The image recording of the containers is preferably triggered on the transport device.

FIG. 6 shows the four images recorded by the image recording devices 22. The connecting strand 12c can be seen in one image, and the marking 10c on the support ring can be seen in a further image. By evaluating these images, the position of the connecting strand 12c relative to the marking 10c can be inferred, and accordingly the rotational position of the container closure 12 relative to the container 10.

A closing device, which closes the containers 10 with the container closures 12 or screws the container closures onto the containers, is preferably provided upstream from the inspection devices shown in FIGS. 3 and 5.

The container closures described within the scope of this invention are preferably screw closures which are particularly preferably made of plastic.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. A method for inspecting containers provided with container closures, wherein the container closure has a closure cap screwed onto a mouth of the container, a securing device arranged on the container below the mouth in a longitudinal direction of the container, a connecting strand that connects the securing device to the closure cap, a first fastening section where the connecting strand is fastened to the closure cap, and a second fastening section with which the connecting strand is arranged on the securing device, wherein the containers are transported by a transport device and inspected by an inspection device, wherein a rotational position of the closure cap relative to the container is determined, and wherein a first marking located on the container is recorded in order to determine the rotational position,
wherein
the rotational position of the container closure is determined from a position of the connecting strand and/or a position of at least one fastening section.

2. The method according to claim 1,
wherein
at least one image of an upper side of the container closure is recorded.

3. The method according to claim 1, wherein
the marking located on the container is received by the same inspection device, such as the position of the connecting strand and/or the position of the fastening section.

4. The method according to claim 1, wherein
the inspection device determines at least one further property characteristic of the container closure and/or of its arrangement on the container.

5. The method according to claim 4, wherein
the further property is selected from a group of properties which contains a color of the container closure, a type of the container closure, an orientation of the container closure on the container, and damage to the container closure or the container.

6. The method according to claim 1, wherein
the inspection device records at least one spatially resolved image of the container and the container closure.

7. The method according to claim 1, wherein
the container is inspected in its longitudinal direction and/or perpendicular to its longitudinal direction.

8. The method according to claim 1, wherein
the container closure is identified.

9. The method according to claim 1, wherein
a type of the container closure is taken into account for determining the rotational position of the container closure.

10. An apparatus for inspecting containers provided with container closures, wherein the container closure has a closure cap screwed onto a mouth of the container, a securing device arranged on the container below the mouth in a longitudinal direction of the container, a connecting strand that connects the securing device to the closure cap, a first fastening section on which the connecting strand is fastened to the closure cap, and a second fastening section with which the connecting strand is arranged on the securing device, having a transport device that transports the containers along a predetermined transport path and having an inspection device for inspecting the containers provided with container closures, which is configured for determining a rotational position of the closure cap relative to the container, and wherein a first marking located on the container is recorded in order to determine the rotational position,
wherein
the inspection device determines the rotational position of the container closure from a position of the connecting strand and/or a position of at least one fastening section.

11. The apparatus according to claim 10, wherein
the apparatus has a closing device which closes the containers with closures.

12. The apparatus according to claim 10, wherein
the apparatus has an image evaluation device which is configured for outputting, from at least one of the recorded images, at least one value which is characteristic of an angular position of the connecting strand and/or at least one fastening section.

13. The method according to claim 2, wherein
the marking located on the container is received by the same inspection device, such as the position of the connecting strand and/or the position of the fastening section.

14. The method according to claim 2, wherein
the inspection device determines at least one further property characteristic of the container closure and/or of its arrangement on the container.

15. The method according to claim 14, wherein
the further property is selected from a group of properties which contains a color of the container closure, a type of the container closure, an orientation of the container closure on the container, and damage to the container closure or the container.

16. The method according to claim 2, wherein
the inspection device records at least one spatially resolved image of the container and the container closure.

17. The method according to claim 2, wherein
the container is inspected in its longitudinal direction and/or perpendicular to its longitudinal direction.

18. The method according to claim 2, wherein
the container closure is identified.

19. The method according to claim 2, wherein
a type of the container closure is taken into account for determining the rotational position of the container closure.

20. The apparatus according to claim 11, wherein
the apparatus has an image evaluation device which is configured for outputting, from at least one of the recorded images, at least one value which is characteristic of an angular position of the connecting strand and/or at least one fastening section.
